(19) United States
(12) Patent Application Publication
(10) Pub. No.: US 2022/0356763 A1
(43) Pub. Date: Nov. 10, 2022

(54) SPRING ROLLER BLIND WHICH CAN BE STARTED AND STOPPED AT WILL

(71) Applicant: Jiefei LU, Zhejiang Province (CN)

(72) Inventor: Jiefei LU, Zhejiang Province (CN)

(21) Appl. No.: 17/460,299

(22) Filed: Aug. 29, 2021

(30) Foreign Application Priority Data
May 8, 2021 (CN) 202120973189.8

(51) Int. Cl. E06B 9/90; E06B 9/60; E06B 9/42

(52) U.S. Cl. CPC E06B 9/90; E06B 9/60; E06B 9/42

(57) ABSTRACT

A spring roller blind which can be started and stopped at will, including a transverse rod and a chuck, wherein the transverse rod is fixedly connected to the chuck, a first torsion spring is arranged on the transverse rod, and one end of the first torsion spring is fixedly connected to one end of the transverse rod away from the chuck. When pulled downwards, the roller blind can be stopped at any position by the friction between embracing springs and a pipe plug; and when a pull ring is pulled, the roller blind can be retracted automatically under the action of the restoring force of the first torsion spring.

### BACKGROUND OF THE INVENTION

The utility model relates to the field of window curtains, and more particularly to a spring roller blind which can be started and stopped at will.

Roller blinds are a kind of window decoration products, which are produced by processing curtain cloth by resin and rolling the curtain cloth into rollers. A roller blind is ascended or descended by pulling a rope or chain, which is convenient to operate and beautiful and simple in appearance, and can make a window frame seem clean and neat and make the whole room seem spacious and elegant.

In the retracting and extending processes of the existing roller blind, a user need to manually pull the rope or chain constantly, the directions of manually pulling the rope or chain are opposite in the retracting and extending processes, so that the processes are too tedious, and the chain or rope is easy to break after a long time of use, causing inconvenience.

### BRIEF SUMMARY OF THE INVENTION

In view of the defects in the prior art, the purpose of the utility model is to provide a spring roller blind which can be started and stopped at will, so as to simplify the retracting and extending processes of a roller blind.

To achieve the above purpose, the utility model provides the following technical solution:

A spring roller blind which can be started and stopped at will, comprising a chuck and a pipe plug which are mutually matched, wherein a limiting part is arranged on the inner wall of the pipe plug, the limiting part comprises a plurality of embracing springs, a first locating sleeve and a second locating sleeve, the first locating sleeve and the second locating sleeve are arranged oppositely, the embracing springs are sheathed outside the first locating sleeve and the second locating sleeve, both ends of each embracing spring are respectively fixedly connected to the first locating sleeve and the second locating sleeve, embracing spaces are formed between the embracing springs and the first locating sleeve & the second locating sleeve for the embracing springs to shrink, the outer diameter of each embracing spring is greater than the inner diameter of the pipe plug, a pulling part is arranged on the chuck, the pulling part is used for releasing the limitation of the limiting part, a cover plate is rotationally connected to the chuck, and the cover plate is fixedly connected to the second locating sleeve.

Preferably: a transverse rod is fixedly connected to the chuck, a first torsion spring is arranged on the transverse rod, one end of the first torsion spring is fixedly connected to one end of the transverse rod away from the chuck, the pipe plug is sheathed on the transverse rod, the other end of the first torsion spring is fixedly connected to the pipe plug, and the limiting part is used for overcoming the restoring force of the first torsion spring.

Preferably: the first locating sleeve is fixedly connected to the transverse rod, and the second locating sleeve is sheathed on the transverse rod.

Preferably: the pulling part comprises a pull ring and a pull rope, one end of the pull rope is fixedly connected to the cover plate, the other end of the pull rope extends out from the chuck and is fixedly connected to the pull ring, and the pull ring can be pulled to make the cover plate rotate.

Preferably: the pulling part comprises a pull rod and a pull rope, one end of the pull rope is fixedly connected to the cover plate, the other end of the pull rope extends out from the chuck and is fixedly connected to the pull rod, and the pull rod can be pulled to make the cover plate rotate.

Preferably: the rotation range of the cover plate is greater than or equal to 90 degrees.

Preferably: a second torsion spring is arranged between the chuck and the cover plate, one end of the second torsion spring is fixedly connected to the chuck, and the other end of the second torsion spring is fixedly connected to the cover plate.

The utility model has the following beneficial effects: the utility model is provided with a limiting part and a pulling part; when pulled downwards, the roller blind can be stopped at any position by the friction between embracing springs and a pipe plug; and when a pull ring is pulled, the roller blind can be retracted automatically under the action of the restoring force of the first torsion spring. Therefore, the extending and retracting processes of the roller blind are simple, a user does not need to pull a rope or chain constantly, and the service lives of the limiting part and the pulling part are prolonged.

### BRIEF DESCRIPTION OF THE DRAWINGS

FIG. 1 is a three-dimensional structural schematic diagram of embodiment 1 of a spring roller blind which can be started and stopped at will of the utility model;

FIG. 2 is an internal structural schematic diagram of embodiment 1 of a spring roller blind which can be started and stopped at will of the utility model;

FIG. 3 is an amplified schematic diagram of place A in FIG. 2; and

FIG. 4 is a local exploded view of embodiment 2 of a spring roller blind which can be started and stopped at will of the utility model.

### DETAILED DESCRIPTION OF THE INVENTION

The utility model is further described below in combination with the drawings and embodiments. In the drawings and embodiments, identical parts and components are indicated by identical reference signs. It should be noted that the words “front”, “back”, “left”, “right”, “upper” and “lower” used in the following description refer to the directions in the drawings, while the words “bottom”, “top”, “inner” and “outer” respectively refer to the directions towards or away from the geometric center of a particular component.

### Embodiment 1:

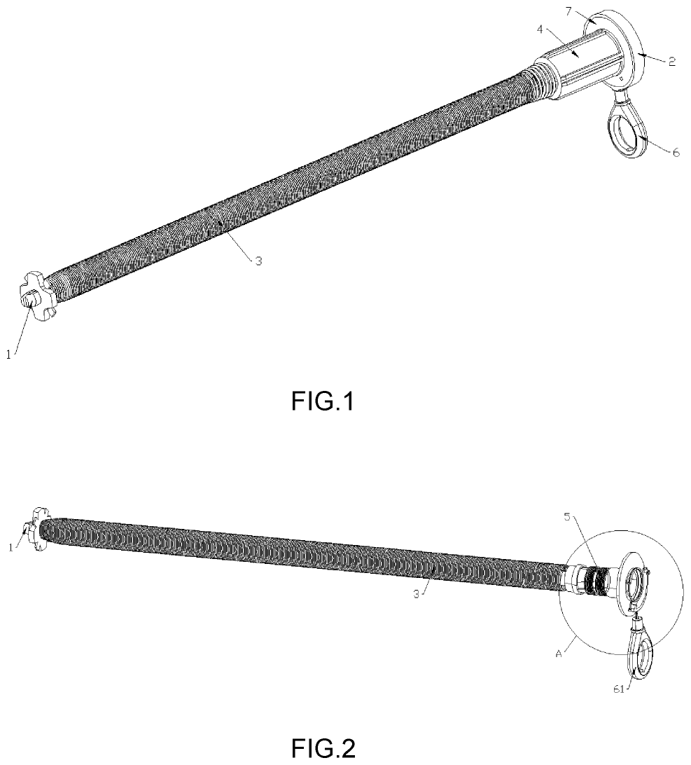

As shown in FIGS. 1 to 3, a spring roller blind which can be started and stopped at will, comprising a transverse rod 1 and a chuck 2, wherein the transverse rod 1 is fixedly connected to the chuck 2, a first torsion spring 3 is arranged on the transverse rod 1, one end of the first torsion spring 3 is fixedly connected to one end of the transverse rod 1 away from the chuck 2, a through groove is formed in one end of the transverse rod 1, one end of the first torsion spring 3 is embedded in the groove and clamped by a workpiece such as an anchor ear to realize fixation, a pipe plug 4 is sheathed on the transverse rod 1, the other end of the first torsion spring 3 is fixedly connected to the pipe plug 4, the first torsion spring 3 is wound on the pipe plug 4 and fixed, a limiting part 5 is arranged between the transverse rod 1 and the pipe plug 4, and the limiting part 5 is used for overcoming the restoring force of the first torsion spring 3. The roller blind can be stopped at any position and will not be retracted upwards under the action of the limiting part 5. The limiting part 5 comprises a plurality of embracing springs 51, a first locating sleeve 52 and a second locating sleeve 53, wherein the first locating sleeve 52 and the second locating sleeve 53 are arranged oppositely, the first locating sleeve 52 is fixedly connected to the transverse rod 1, the second locating sleeve 53 is sheathed on the transverse rod 1, the embracing springs 51 are sheathed outside the first locating sleeve 52 and the second locating sleeve 53, both ends of each embracing spring 51 are respectively fixedly connected to the first locating sleeve 52 and the second locating sleeve 53, and embracing spaces are formed between the embracing springs 51 and the first locating sleeve 52 & the second locating sleeve 53 for the embracing springs 51 to shrink. The outer diameter of each embracing spring 51 is greater than the inner diameter of the pipe plug 4, so that interference fit is formed between the embracing springs 51 and the pipe plug 4. The embracing springs 51 are pressed against the inner wall of the pipe plug 4 to apply a pressure to the pipe plug 4, so as to increase the friction between the embracing springs 51 and the pipe plug 4, make the friction greater than the restoring force of the first torsion spring 3, make the first torsion spring 3 unable to drive the pipe plug 4 to rotate, and make the roller blind unable to be retracted upwards. When the roller blind is pulled downwards by a user, the pulling force of the user is greater than the friction, so that the pipe plug 4 is rotated, the roller blind is pulled downwards, and the function of the roller blind being stopped at any position is realized. A pulling part 6 is arranged on the chuck 2, the pulling part 6 is used for releasing the limitation of the limiting part 5, the pulling part 6 comprises a pull ring 61 and a pull rope 62, a cover plate 7 is rotationally connected to the chuck 2, one end of the pull rope 62 is fixedly connected to the cover plate 7, the other end of the pull rope 62 extends out from the chuck 2 and is fixedly connected to the pull ring 61, the cover plate 7 is fixedly connected to the second locating sleeve 53, and the pull ring 61 can be pulled to make the cover plate 7 rotate. As the cover plate 7 is fixedly connected to the second locating sleeve 53, the second locating sleeve 53 is rotated to make the embracing springs 51 shrink, make the pressure of the embracing springs 51 against the pipe plug 4 reduced, make the friction the embracing springs 51 against the pipe plug 4 reduced and even be 0, make the first torsion spring 3 able to drive the pipe plug 4 to rotate, and make the roller blind retracted upwards, so that automatic retraction of the roller blind is realized. The user only need to pull the pull ring 61, and retraction is realized by the restoring force of the embracing springs 51 when the pull ring 61 is restored. Compared with a process of pulling a chain or rope constantly, the process of the utility model is simplified, and the service lives of the limiting part 5 and the pulling part 6 are prolonged. A second torsion spring 8 is arranged between the chuck 2 and the cover plate 7, one end of the second torsion spring 8 is fixedly connected to the chuck 2, and the other end of the second torsion spring 8 is fixedly connected to the cover plate 7. When a pull rod is hung on the pull ring 61, the pull ring 61 may be pulled downwards due to the gravity of the pull rod, thus to make the roller blind be always in a retracted state. The force required for the pull ring 61 to be pulled is increased by the second torsion spring 8, and the force for the pull ring 61 to be pulled is changed into the forces of two embracing springs 51 plus the force of the second torsion spring 8.

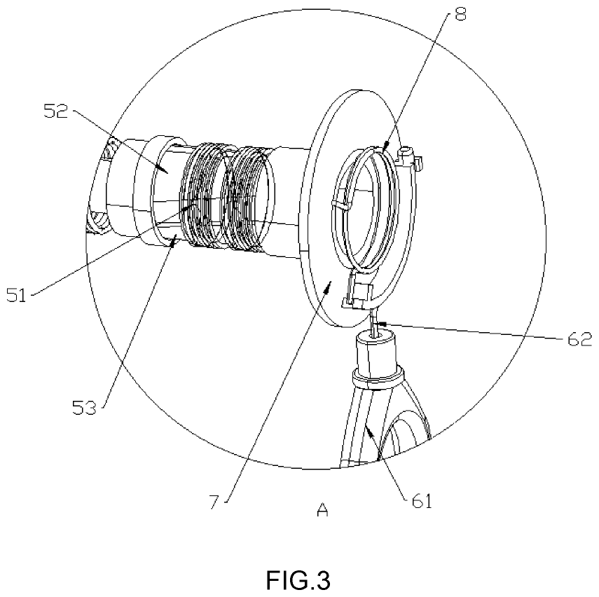

As shown in FIG. 3, two embracing springs 51 are arranged, and an interval exists between the two embracing springs 51 to ensure the friction between the embracing springs 51 and the pipe plug 4.

As shown in FIG. 3, the rotation range of the cover plate 7 is greater than or equal to 90 degrees to ensure the shrinkage degree of the embracing springs 51 and make the embracing springs 51 and the pipe plug 4 not in contact with each other.

### Embodiment 2:

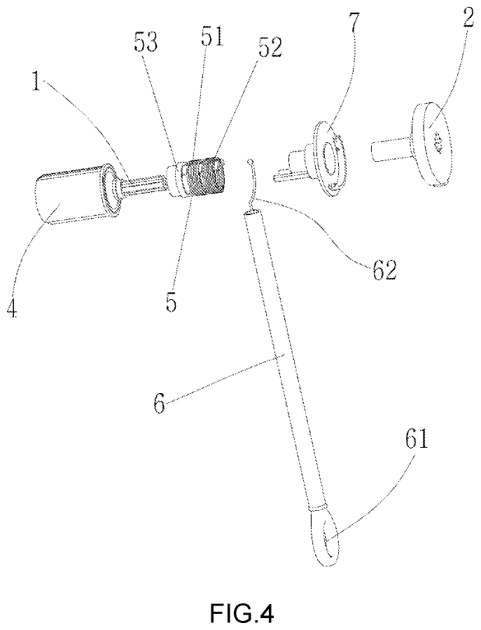

As shown in FIG. 4, a spring roller blind which can be started and stopped at will, comprising a transverse rod 1 and a chuck 2, wherein the transverse rod 1 is fixedly connected to the chuck 2, a first torsion spring 3 (not shown in the figure) is arranged on the transverse rod 1, one end of the first torsion spring 3 is fixedly connected to one end of the transverse rod 1 away from the chuck 2, a through groove is formed in one end of the transverse rod 1, one end of the first torsion spring 3 is embedded in the groove and clamped by a workpiece such as an anchor ear to realize fixation, a pipe plug 4 is sheathed on the transverse rod 1, the other end of the first torsion spring 3 is fixedly connected to the pipe plug 4, the first torsion spring 3 is wound on the pipe plug 4 and fixed, a limiting part 5 is arranged between the transverse rod 1 and the pipe plug 4, and the limiting part 5 is used for overcoming the restoring force of the first torsion spring 3. The roller blind can be stopped at any position and will not be retracted upwards under the action of the limiting part 5. The limiting part 5 comprises a plurality of embracing springs 51, a first locating sleeve 52 and a second locating sleeve 53, wherein the first locating sleeve 52 and the second locating sleeve 53 are arranged oppositely, the first locating sleeve 52 is fixedly connected to the transverse rod 1, the second locating sleeve 53 is sheathed on the transverse rod 1, the embracing springs 51 are sheathed outside the first locating sleeve 52 and the second locating sleeve 53, both ends of each embracing spring 51 are respectively fixedly connected to the first locating sleeve 52 and the second locating sleeve 53, and embracing spaces are formed between the embracing springs 51 and the first locating sleeve 52 & the second locating sleeve 53 for the embracing springs 51 to shrink. The outer diameter of each embracing spring 51 is greater than the inner diameter of the pipe plug 4, so that interference fit is formed between the embracing springs 51 and the pipe plug 4. The embracing springs 51 are pressed against the inner wall of the pipe plug 4 to apply a pressure to the pipe plug 4, so as to increase the friction between the embracing springs 51 and the pipe plug 4, make the friction greater than the restoring force of the first torsion spring 3, make the first torsion spring 3 unable to drive the pipe plug 4 to rotate, and make the roller blind unable to be retracted upwards. When the roller blind is pulled downwards by a user, the pulling force of the user is greater than the friction, so that the pipe plug 4 is rotated, the roller blind is pulled downwards, and the function of the roller blind being stopped at any position is realized. A pulling part 6 is arranged on the chuck 2, the pulling part 6 is used for releasing the limitation of the limiting part 5, the pulling part 6 comprises a pull rod 61 and a pull rope 62, a cover plate 7 is rotationally connected to the chuck 2, one end of the pull rope 62 is fixedly connected to the cover plate 7, the other end of the pull rope 62 extends out from the chuck 2 and is fixedly connected to the pull rod 61, the cover plate 7 is fixedly connected to the second locating sleeve 53, and the pull rod 61 can be pulled to make the cover plate 7 rotate. As the cover plate 7 is fixedly connected to the second locating sleeve 53, the second locating sleeve 53 is rotated to make the embracing springs 51 shrink, make the pressure of the embracing springs 51 against the pipe plug 4 reduced, make the friction the embracing springs 51 against the pipe plug 4 reduced and even be 0, make the first torsion spring 3 able to drive the pipe plug 4 to rotate, and make the roller blind retracted upwards, so that automatic retraction of the roller blind is realized. The user only need to pull the pull rod 61, and retraction is realized by the restoring force of the embracing springs 51 when the pull rod 61 is restored. Compared with a process of pulling a chain or rope constantly, the process of the utility model is simplified, and the service lives of the limiting part 5 and the pulling part 6 are prolonged. A second torsion spring 8 is arranged between the chuck 2 and the cover plate 7, one end of the second torsion spring 8 is fixedly connected to the chuck 2, and the other end of the second torsion spring 8 is fixedly connected to the cover plate 7. When a pull rod is hung on the pull rod 61, the pull rod 61 may be pulled downwards due to the gravity of the pull rod, thus to make the roller blind be always in a retracted state. The force required for the pull rod 61 to be pulled is increased by the second torsion spring 8, and the force for the pull rod 61 to be pulled is changed into the forces of two embracing springs 51 plus the force of the second torsion spring 8.

Operating principle: as the roller blind is fixedly connected to the pipe plug 4, when the roller blind is pulled downwards by the user, the pulling force overcomes the friction between the pipe plug 4 and the embracing springs 51, so that the pipe plug 4 is rotated, and the roller blind is moved downwards at the same time. At this moment, the first torsion spring 3 is in a tightening state, the friction between the pipe plug 4 and the embracing springs 51 is greater than the restoring force of the first torsion spring 3, so that the roller blind can be stopped at any position. When the roller blind need to be retracted, the pull ring 61 or pull rod 61 is pulled, so that the cover plate 7 and the second locating sleeve 53 are rotated, the embracing springs 51 are in a tightening state, the pressure against the pipe plug 4 is reduced, the friction against the pipe plug 4 is reduced, the pipe plug 4 is rotated under the action of the restoring force of the first torsion spring 3, and the roller blind is retracted.

The above only describes the preferred embodiments of the utility model, but the protection scope of the utility model is not limited to the above-mentioned embodiments. All technical solutions under the conception of the utility model should belong to the protection scope of the utility model. It should be noted that for those ordinary skilled in the art, several improvements and modifications can be made without departing from the principles of the utility model, and these improvements and modifications should also be considered to be within the protection scope of the utility model.

What is claimed is:

1: A spring roller blind which can be started and stopped at will, comprising a chuck (2) and a pipe plug (4) which are mutually matched, wherein a limiting part (5) is arranged on the inner wall of the pipe plug (4), the limiting part (5) comprises a plurality of embracing springs (51), a first locating sleeve (52) and a second locating sleeve (53), the first locating sleeve (52) and the second locating sleeve (53) are arranged oppositely, the embracing springs (51) are sheathed outside the first locating sleeve (52) and the second locating sleeve (53), both ends of each embracing spring (51) are respectively fixedly connected to the first locating sleeve (52) and the second locating sleeve (53), embracing spaces are formed between the embracing springs (51) and the first locating sleeve (52) & the second locating sleeve (53) for the embracing springs (51) to shrink, the outer diameter of each embracing spring (51) is greater than the inner diameter of the pipe plug (4), a pulling part (6) is arranged on the chuck (2), the pulling part (6) is used for releasing the limitation of the limiting part (5), a cover plate (7) is rotationally connected to the chuck (2), and the cover plate (7) is fixedly connected to the second locating sleeve (53).

2: The spring roller blind which can be started and stopped at will according to claim 1, wherein a transverse rod (1) is fixedly connected to the chuck (2), a first torsion spring (3) is arranged on the transverse rod (1), one end of the first torsion spring (3) is fixedly connected to one end of the transverse rod (1) away from the chuck (2), the pipe plug (4) is sheathed on the transverse rod (1), the other end of the first torsion spring (3) is fixedly connected to the pipe plug (4), and the limiting part (5) is used for overcoming the restoring force of the first torsion spring (3).

3: The spring roller blind which can be started and stopped at will according to claim 2, wherein the first locating sleeve (52) is fixedly connected to the transverse rod (1), and the second locating sleeve (53) is sheathed on the transverse rod (1).

4: The spring roller blind which can be started and stopped at will according to claim 3, wherein the pulling part (6) comprises a pull ring (61) and a pull rope (62), one end of the pull rope (62) is fixedly connected to the cover plate (7), the other end of the pull rope (62) extends out from the chuck (2) and is fixedly connected to the pull ring (61), and the pull ring (61) can be pulled to make the cover plate (7) rotate.

5: The spring roller blind which can be started and stopped at will according to claim 3, wherein the pulling part (6) comprises a pull rod (61) and a pull rope (62), one end of the pull rope (62) is fixedly connected to the cover plate (7), the other end of the pull rope (62) extends out from the chuck (2) and is fixedly connected to the pull rod (61), and the pull rod (61) can be pulled to make the cover plate (7) rotate.

6: The spring roller blind which can be started and stopped at will according to claim 4, wherein the rotation range of the cover plate (7) is greater than or equal to 90 degrees.

7: The spring roller blind which can be started and stopped at will according to claim 4, wherein a second torsion spring (8) is arranged between the chuck (2) and the cover plate (7), one end of the second torsion spring (8) is fixedly connected to the chuck (2), and the other end of the second torsion spring (8) is fixedly connected to the cover plate (7).
